(19) United States
(12) Patent Application Publication
(10) Pub. No.: US 2005/0248166 A1
(43) Pub. Date: Nov. 10, 2005

(54) Power assisted hand shovel and method of producing same

(76) Inventor: Jack P. Warren, Bloomfield Hills, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 10/839,418

(22) Filed: May 5, 2004

(51) Int. Cl. A01B 1/02

(52) U.S. Cl. 294/49

(57) ABSTRACT

A power assisted hand shovel includes a stationary blade that is configured to receive dirt and other material to be shoveled and to facilitate transport of the material away from the area being shoveled. A handle has a proximal end and a distal end which is attached to the stationary blade. A movable blade is disposed adjacent the stationary blade, and is configured to reciprocating linear motion relative to the stationary blade to impact the dirt and other material being shoveled. This facilitates receipt of the material by the stationary blade. An actuator is configured to cooperate with the movable blade to facilitate imparting a linear motion to the movable blade in at least one direction. This facilitates the impaction of the dirt and other material to be shoveled.

### BACKGROUND OF THE INVENTION

1. Field of the Invention

The present invention relates to a power assisted hand shovel and a method of producing a power assisted hand shovel.

2. Background Art

The task of manually digging a hole can be time consuming and labor intensive. This is particularly true in geographic regions having dense soil, such as hard packed clay. Moreover, even in areas where the soil is looser, digging may still be a laborious task during the colder seasons when the upper surface of the soil is prone to freezing. Although equipment, such as a back hoe, may be purchased or rented to assist in the digging of holes, the use of such equipment may not be practical and may be cost prohibitive.

One attempt to address this problem is discussed in U.S. Pat. No. 3,548,953 issued to Richardson, Sr. on Dec. 22, 1970. Richardson, Sr. describes a shrubbery and plant digger that includes a cutting blade attached to a carrier tube. A gasoline engine imparts a reciprocating motion to the carrier tube, thereby reciprocating the blade to facilitate digging. One limitation of the device described in Richardson, Sr. is that the engine reciprocates the entire carrier tube and blade assembly. Having to move such a large mass is an inefficient use of the power output by the engine. For example, the amount of mass moved by the engine could be reduced if only the blade were reciprocated, not the carrier tube and the blade. The amount of mass moved by the engine could be further reduced, if only a portion of the blade, or a separate, smaller blade were reciprocated, instead of the entire blade. Therefore, a need exists for a power assisted hand shovel that includes two blades and an actuator configured to move one of the blades relative to the other.

### SUMMARY OF THE INVENTION

Accordingly, the present invention provides a power assisted hand shovel including two blades and an actuator that moves one of the blades relative to the other.

The invention also provides a power assisted hand shovel including a first blade configured to receive material to be shoveled and to facilitate transport of the material away from an area being shoveled. A handle has a proximal end and a distal end which is attached to the first blade. A second blade is disposed adjacent the first blade, and is configured for reciprocating linear motion relative to the first blade to impact the material to be shoveled. This facilitates receipt of the material by the first blade. An actuator is configured to cooperate with the second blade to facilitate imparting linear motion to the second blade in at least one direction. This facilitates the impaction of the material to be shoveled.

The invention further provides a power assisted hand shovel including a first blade configured to receive material to be shoveled and to facilitate transport of the material away from an area being shoveled. A handle has a proximal end and an distal end; the distal end is attached to the first blade. A second blade is disposed adjacent the first blade, and is configured for reciprocating linear motion relative to the first blade to impact the material being shoveled. This facilitates receipt of the material by the first blade. A frame is configured to support the second blade and to maintain the second blade adjacent the first blade. An actuator is configured to cooperate with the frame to impart linear motion to the frame in at least one direction, thereby moving the second blade and facilitating the impaction of the material to be shoveled.

The invention also provides a method for producing a power assisted hand shovel having a first blade and an elongate handle attached to the first blade. The method includes disposing a frame around at least a portion of the first blade. A second blade is attached to the frame, and an actuator is operatively connected to the frame to facilitate imparting linear motion to the frame for moving the second blade relative to the first blade.

### BRIEF DESCRIPTION OF THE DRAWINGS

FIG. 1 is a perspective view of a power assisted hand shovel in accordance with the present invention;

FIGS. 2A and 2B are sectional views of a portion of the shovel blades shown in FIG. 1;

FIG. 3 is a sectional view of a portion of an alternative embodiment of the present invention, including a plastic glide;

FIG. 4 is a side plan view of a portion of an alternative embodiment of the present invention; and

FIG. 5 is a perspective view of a rotor assembly used to transfer rotational motion into linear motion.

### DETAILED DESCRIPTION OF THE PREFERRED EMBODIMENT(S)

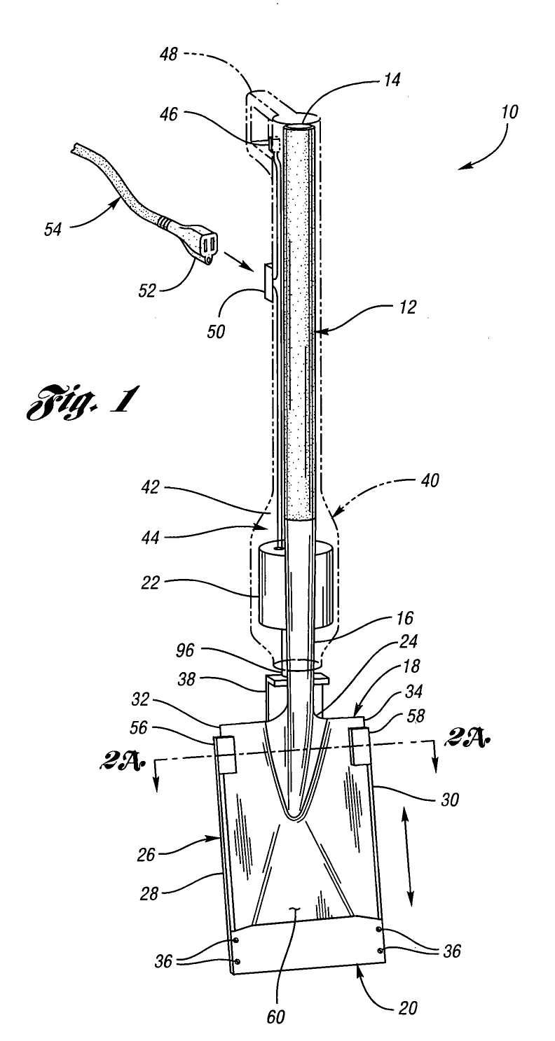

FIG. 1 shows a power assisted hand shovel 10 in accordance with the present invention. The shovel 10 includes a handle 12 having a proximal end 14 and a distal end 16. The shovel 10 also includes a first blade, or stationary blade 18. A second blade, or movable blade 20, is disposed adjacent the stationary blade 18, and is configured for reciprocating linear motion relative to the stationary blade 18. As explained more fully below, an actuator, or motor 22 is configured to cooperate with the movable blade 20 to impart linear motion to the movable blade 20 in at least one direction. This facilitates impaction of material to be shoveled by the movable blade 20, which facilitates receipt of the material by the stationary blade 18. Being stationary, the stationary blade 18 is configured to receive the material being shoveled and to facilitate transport of the material away from the area being shoveled. Thus, the stationary blade 18 may be moved by a user of the shovel 10, but it is stationary relative to the movable blade 20.

As shown in FIG. 1, the stationary blade 18 includes a shank 24 that may be forged from a single piece of metal with the stationary blade 18. Thus, the distal end 16 of the handle 12 is attached to the stationary blade 18 at the shank 24. Supporting the movable blade 20 is a frame 26. The frame 26 maintains the movable blade 20 adjacent to the stationary blade 18, and further, cooperates with the motor 22 to transfer motion from the motor 22 to the movable blade 20. The frame 26 includes first and second edge members 28, 30. Each of the edge members 28, 30 is disposed adjacent a respective edge 32, 34 of the stationary blade 18.

As shown in FIG. 1, each of the edge members 28, 30 have a portion of the movable blade 20 attached thereto. In particular, the movable blade 20 is attached to first and second edge members 28, 30 via threaded fasteners 36, which facilitates removal of the movable blade 20 from the frame 26 to facilitate maintenance and/or replacement of the movable blade 20. Unlike other power shovels which reciprocate an entire blade and shank assembly, as well as a portion of the shovel handle, the shovel 10 more efficiently uses the power of the motor 22. As shown in FIG. 1, the frame 26 does not have a large mass, and the movable blade 20 is much smaller than the stationary blade 18. Thus, much of the power of the motor 22 is available to the movable blade 20.

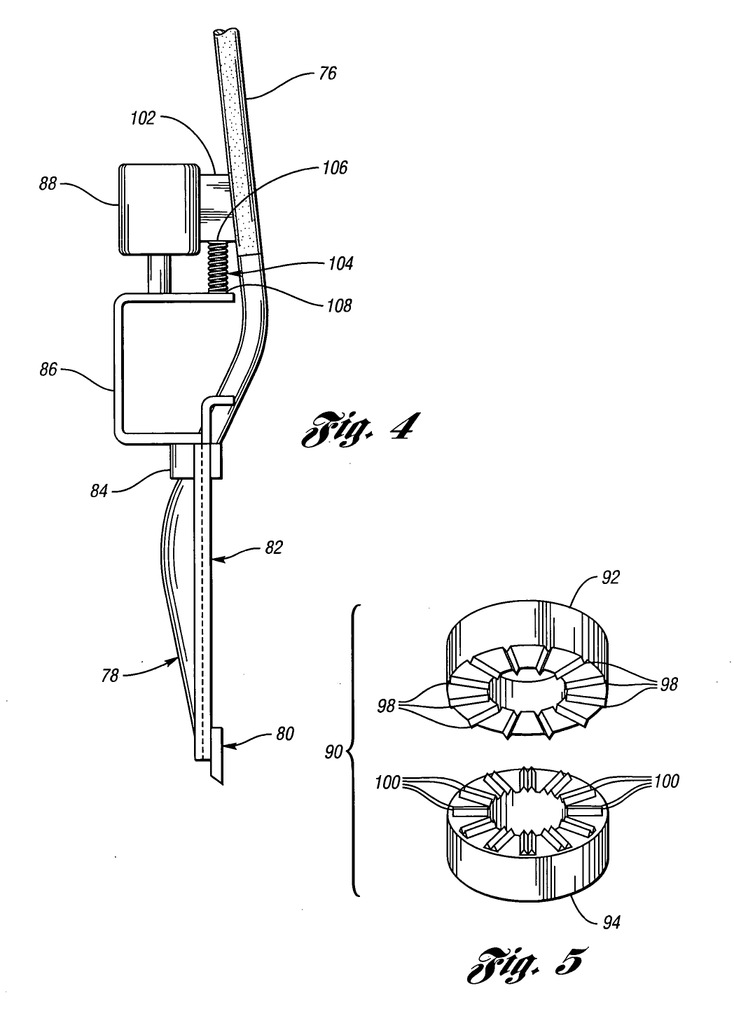

As described in more detail with reference to FIG. 4, the shovel 10 includes a bracket 38 disposed between the motor 22 and the frame 26 to facilitate movement of the frame 26 by the motor 22. Like the frame 26, the mass of the bracket 38 is not very great; thus, not much power is needed to move the frame 26 and bracket 38. Therefore, much of the power of the motor 22 is used by the movable blade 20 as it impacts the material being shoveled.

The shovel 10 also includes a housing 40, shown in phantom in FIG. 1. The housing 40 is disposed around the motor 22 and the handle 12, and provides a conduit 42 from the motor 22 to the proximal end 14 of the handle 12. The conduit 42 is useful to provide a pathway for electrical wiring 44 going to and from the motor 22. The wires 44 connect the motor 22 with a trigger switch 46 that is disposed in a handle portion 48 of the housing 40. It may be convenient to manufacture the housing 40 from a molded polymer, such that the handle portion 48 could be integrally molded therewith. The housing 40 also provides an electrical connector 50, which can be configured with male prongs to mate with the female end 52 of an extension cord 54. An integrally molded strap (not shown), or other retaining device, can be used to maintain the electrical connection between the extension cord 54 and the electrical connector 50 while the shovel 10 is being used.

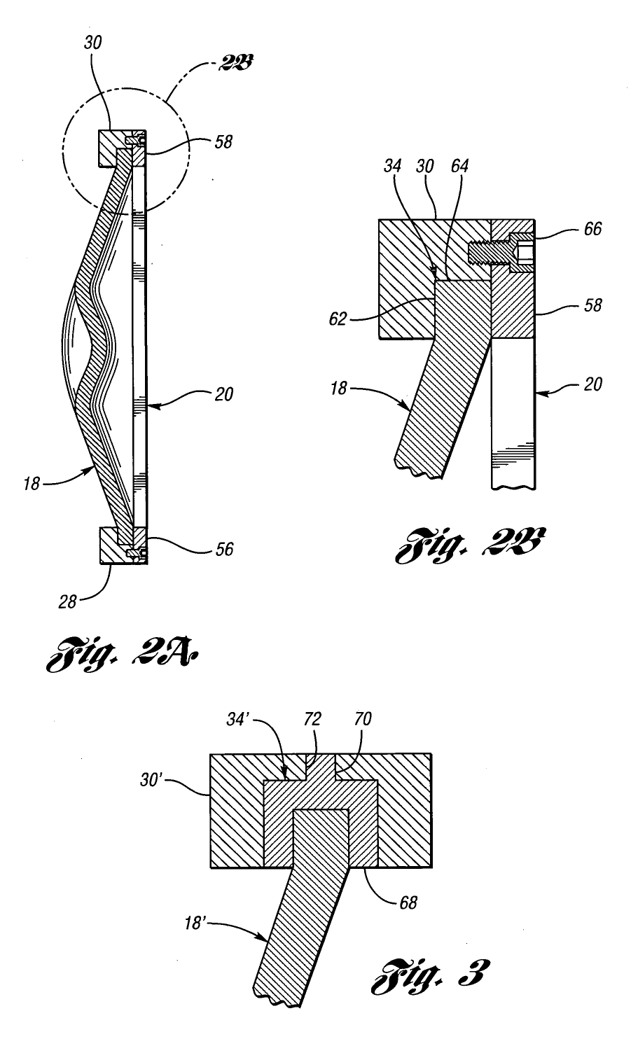

The frame 26 also includes first and second retaining tabs 56, 58. The tabs 56, 58 are removably attached to a respective edge member 28, 30, and are disposed adjacent a front surface 60 of the stationary plate 18. The tabs 56, 58 help to maintain the frame 26 proximate the stationary blade 18. FIG. 2A shows a section of the shovel 10 taken through line 2A-2A in FIG. 1. FIG. 2A illustrates how the frame 26, and in particular the edge members 28, 30 and retaining tabs 56, 58 help to maintain the frame 26 proximate the stationary blade 18. FIG. 2B shows a detail taken from one section of FIG. 2A. In particular, FIG. 2B shows that the edge member 30 is disposed around a back portion 62 and a side portion 64 of the edge 34 of the stationary blade 18. In addition, FIG. 2B shows how retaining tab 58 is attached to the edge member 30 with a threaded fastener 66. Thus, the retaining tabs 56, 58 can be easily removed to facilitate disassembly of the frame 26. In addition, because the movable blade 20 is also removable using threaded fasteners 36, the entire frame 26 can be disassembled and removed from the stationary blade 18.

Although various materials, such as one or more metals, or even high impact polymers, may be used for the frame 26 and/or the movable blade 20, it is also contemplated that the movable blade 20 can be made from a ceramic material. This may reduce the frequency of sharpening or replacing the movable blade 20, and may generally extend its useful life. Of course, the frame 26 may be made entirely from metal, and if desired, welded together. When the frame 26 is made from metal, it may be desirable to provide a ceramic or polymeric insert between the moving surfaces, such that metal-to-metal contact is avoided. For example, FIG. 3 shows a cross section of an edge member 30′; which is generally analogous to the edge member 30 shown in FIGS. 1 and 2. The edge member 30′ wraps entirely around a stationary blade 18′, thus eliminating the need for a retaining tab.

The embodiment shown in FIG. 3 also includes a plastic glide 68 that is disposed between the edge member 30′ and the edge 34′, thereby providing a wear surface when a movable blade moves relative to the stationary blade. It is understood that a second glide will be used on the opposite side of the stationary blade 18′. Moreover, any number of glides, such as the glide 68, can be used between an edge member and the edge of a stationary blade, such as the stationary blade 18′. As shown in FIG. 3, the glide 68 includes a projection 70 that snap fits into an aperture 72 in the edge member 30′.

FIG. 4 shows a portion of an alternative embodiment of a power assisted hand shovel 74 in accordance with the present invention. The shovel 74 includes a handle 76, a stationary blade 78, and a movable blade 80. As with the embodiment shown in FIG. 1, the shovel 74 includes a frame 82 which is disposed around a portion of the perimeter of the stationary blade 78. The frame 82 also includes a back rail 84 which is connected to a bracket 86. The bracket 86 generally corresponds to the bracket 38 shown in FIG. 1, and it is contemplated that the frame 26 will include a back rail generally configured as the back rail 84. Of course, other means of connecting a frame to a motor, such as the frame 26 to the motor 22, are contemplated within the scope of the present invention.

Schematically illustrated in FIG. 4 is an actuator 88. The actuator 88 may be an electric motor, such as the motor 22 shown in FIG. 1. Alternatively, the actuator may be an electric solenoid, an internal combustion engine, a pneumatic hammer, or any other device effective to transfer linear motion to the bracket 86. In the case where an actuator produces rotary motion—e.g., the motor 22—a transfer mechanism may be used for transferring the rotational motion output by the actuator into linear motion. One such mechanism is a rotor assembly 90, shown in FIG. 5. The rotor assembly 90 includes first and second pieces 92, 94. The first piece 92 may be attached to an actuator shaft, such as the shaft 96 shown in FIG. 1. The first piece 92 can be attached to the shaft 96 with set screws, or by any method effective to facilitate rotation of the first piece 92 when the shaft 96 rotates. The second piece 94 is rotationally fixed, such that as the shaft 96 rotates, thereby rotating the first piece 92, the teeth 98 on the first piece 92 ride over the teeth 100 on the second piece 94. This causes the shaft 96 to move linearly as it rotates.

A spring (not shown) can be used to bias the first and second pieces 92, 94 together so they maintain contact as the shaft 96 rotates. Alternatively, a spring may be used to bias the first and second pieces 92, 94 apart. In such a configuration, the two pieces 92, 94 would act like a clutch, only coming into contact when a force was applied to the movable blade 20. This would allow an operator to actuate the trigger switch 46 to rotate the shaft 96 without moving the movable blade 20. Only after the movable blade 20 pushed up on the frame 26—e.g., by contacting the ground—would the two pieces 92, 94 engage, thereby reciprocating the movable blade 20.

Using a transfer mechanism, such as the rotor assembly 90, the total linear travel can be determined by the combined height of the teeth 98, 100. For example, if it is desired to have the movable blade 20 have a total stroke of ¼ inch, each of the teeth 98, 100 can be configured to be ⅛ inch high. Of course, other types of transfer mechanisms may be used to transfer rotational motion of an actuator into linear motion of a movable blade. For example, a slider crank mechanism, commonly used in machinery to transfer rotational motion into linear motion, may be used. Another example of a transfer mechanism is a wobble drive. Similarly, a cam mechanism may be used. In one such embodiment, a motor with a shaft generally perpendicular to the motion of a movable blade is used. An eccentric device, such as a cam, is rotated by the motor shaft, and a cam follower is used to move the frame and movable blade.

Some transfer mechanisms, such as some cam arrangements, may impart motion to a movable blade in only one direction—i.e., downward. In such embodiments, another device, such as a spring, may be used to move the movable blade upward. Returning to FIG. 4, it is shown that the actuator 88 is attached to the handle 76 with a mounting bracket 102. Disposed between the mounting bracket 102 and the bracket 86 is a tension spring 104. The spring 104 has a first end 106 fixed to the mounting bracket 102. A second end 108 of the spring 104 is attached to the bracket 86, which means that it is movable with the frame 82. A spring, such as the spring 104, may be useful when an actuator is configured to impart motion in only one direction. For example, if the actuator 88 is a pneumatic hammer, the pneumatic hammer will move the bracket 86, the frame 82, and the movable blade 80 downward into an extended position. The spring 104 will then return the movable blade 80 to a retracted position via the bracket 86 and the frame 82. Thus, any number of different types of actuators may be used with the present invention.

A power assisted hand shovel, such as the shovel 10 shown in FIG. 1, can be produced by executing a number of steps. For example, after a stationary blade is attached to a distal end of a handle, a frame can then be disposed around a portion of the stationary blade. A movable blade, such as the blade 20 is then attached to the frame, which is then operatively connected to an actuator to facilitate imparting linear motion to the frame for moving the movable blade relative to the stationary blade. The movable blade can be removably attached to the frame to facilitate maintenance and/or replacement of the movable blade should it require service. Thus, the present invention may be produced as a new shovel, or an existing shovel can be retrofit with the actuator, frame and movable blade to produce a power assisted hand shovel in accordance with the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A power assisted hand shovel, comprising
a first blade configured to receive material to be shoveled and to facilitate transport of the material away from an area being shoveled;
a handle having a proximal end and a distal end, the distal end being attached to the first blade;
a second blade disposed adjacent the first blade and configured for reciprocating linear motion relative to the first blade to impact the material to be shoveled, thereby facilitating receipt of the material by the first blade; and
an actuator configured to cooperate with the second blade to facilitate imparting linear motion to the second blade in at least one direction, thereby facilitating the impaction of the material to be shoveled.

2. The shovel of claim 1, wherein the actuator includes an electric motor having a rotatable shaft and a transfer mechanism for transferring rotational motion of the shaft to linear motion.

3. The shovel of claim 1, wherein the actuator includes at least one of an internal combustion engine, a solenoid, and a pneumatic hammer.

4. The shovel of claim 1, further comprising a housing disposed around at least a portion of the actuator and at least a portion of the handle, the housing providing a conduit from the actuator to the proximal end of the handle.

5. The shovel of claim 1, further comprising a frame configured to support the second blade and to cooperate with the actuator to transfer motion from the actuator to the second blade.

6. The shovel of claim 5, wherein the frame includes first and second edge members, each of the edge members being disposed adjacent a respective edge of the first blade and having a portion of the second blade attached thereto.

7. The shovel of claim 6, further comprising first and second glides, each of the glides being disposed between a respective edge member of the frame and a respective edge of the first blade, thereby providing a respective wear surface when the second blade moves relative to the first blade.

8. The shovel of claim 6, wherein the frame further includes first and second retaining tabs removably attached to a respective edge member and disposed adjacent a front surface of the first blade to help maintain the frame proximate the first blade.

9. The shovel of claim 6, further comprising a spring having a first end fixed and second end movable with the frame, the spring being configured to return the second blade from an extended position to a retracted position.

10. A power assisted hand shovel, comprising
a first blade configured to receive material to be shoveled and to facilitate transport of the material away from an area being shoveled;
a handle having a proximal end and a distal end, the distal end being attached to the first blade;
a second blade disposed adjacent the first blade and configured for reciprocating linear motion relative to the first blade to impact the material to be shoveled, thereby facilitating receipt of the material by the first blade;
a frame configured to support the second blade and maintain the second blade adjacent the first blade; and
an actuator configured to cooperate with the frame to impart linear motion to the frame in at least one direction, thereby moving the second blade and facilitating the impaction of the material to be shoveled.

11. The shovel of claim 10, wherein the second blade is removable from the frame to facilitate maintenance and replacement of the second blade.

12. The shovel of claim 10, wherein the actuator includes an electric motor having a rotatable shaft and a transfer mechanism for transferring rotational motion of the shaft to linear motion.

13. The shovel of claim 10, wherein the actuator includes at least one of an internal combustion engine, a solenoid, and a pneumatic hammer.

14. The shovel of claim 10, further comprising a housing disposed around at least a portion of the actuator and at least a portion of the handle, the housing providing a conduit from the actuator to the proximal end of the handle.

15. The shovel of claim 10, further comprising a spring having a first end fixed and a second end movable with the frame, the spring being configured to return the second blade from an extended position to a retracted position.

16. The shovel of claim 10, wherein the frame includes first and second edge members, each of the edge members being disposed adjacent a respective edge of the first blade and having a portion of the second blade attached thereto.

17. The shovel of claim 16, further comprising first and second glides, each of the glides being disposed between a respective edge member of the frame and a respective edge of the first blade, thereby providing a respective wear surface when the second blade moves relative to the first blade.

18. The shovel of claim 16, wherein the frame further includes first and second retaining tabs removably attached to a respective edge member and disposed adjacent a front surface of the first blade to maintain the frame proximate the first blade.

19. A method for producing a power assisted hand shovel having a first blade and an elongate handle attached to the first blade, the method comprising:
disposing a frame around at least a portion of the first blade;
attaching a second blade to the frame; and
operatively connecting an actuator to the frame to facilitate imparting linear motion to the frame for moving the second blade relative to the first blade.

20. The method of claim 19, wherein the second blade is removably attached to the frame to facilitate maintenance and replacement of the second blade.
